(19) United States
(12) Patent Application Publication
(10) Pub. No.: US 2014/0035924 A1
(43) Pub. Date: Feb. 6, 2014

(54) TREND HIGHLIGHTING

(71) Applicant: Apollo Group, Inc., Phoenix, AZ (US)

(72) Inventors: Michael Wasson, Pittsburgh, PA (US); Robert GM Hausmann, Pittsburgh, PA (US)

(73) Assignee: Apollo Group, Inc., Phoenix, AZ (US)

(21) Appl. No.: 13/957,085

(22) Filed: Aug. 1, 2013

Related U.S. Application Data
(60) Provisional application No. 61/678,587, filed on Aug. 1, 2012.

(51) Int. Cl. G06T 11/20

(52) U.S. Cl. CPC G06T 11/206
USPC 345/440

(57) ABSTRACT

A method for generating hints for math problems is provided. In response to a request for a hint from a student in a unit of instruction with a scatter plot, shapes are generated based on points in the scatter plot. A convex hull is generated based on the generated shapes.

### PRIORITY CLAIM

This application claims benefit of Provisional Appln. 61/678,587, filed Aug. 1, 2012, the entire contents of which is hereby incorporated by reference as if fully set forth herein, under 35 U.S.C. §119(e).

### FIELD OF THE INVENTION

The present invention relates generally to trend highlighting, and more specifically to highlighting points on a graph.

### BACKGROUND

In some circumstances, it is desirable to highlight a set of points to demonstrate a statistical trend. In particular, this may be desirable in a unit of instruction with a scatter plot on which the student needs to draw (approximately) the line of best fit. The student may do this by dragging two point controls over the plot, which uniquely define a line of best fit. The highlighted area is to give them an idea of where they could draw a best fit line that would be accepted by the tutor.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 represents a user interface on which an embodiment may be implemented.

FIG. 2 represents a user interface on which an embodiment may be implemented.

FIG. 3 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

In an embodiment, a set of points is provided. For example, a graph may be provided to a student via an intelligent tutor computer program such as a cognitive tutoring system. The points on the graph may be a scatter plot, and the student may be required to identify the best fit line that identifies the trend associated with the points.

In an embodiment, a computer application such as a cognitive tutor application may detect the need to highlight a set of points on a graph, such as those in the scatter plot described earlier. Hints may be triggered when the student answers a question incorrectly. In addition, students may ask for hints.

In an embodiment, the student does not know what to do with the scatter plot, and needs a hint to help him determine where to draw the best-fit line. One way to give the student a hint without giving the answer away is to draw a convex hull around the dots and suggest that the student bisect the circle. The convex hull of a set of points or shapes is the smallest convex set (a set that doesn't curve inwards or have any dents) containing those points or shapes. This is a good approximation for a best-fit line. If the student does not understand what to do after the hint, the best fit line may then be drawn for the student.

Although the line drawn by the student may not be exactly correct, a reasonable variation may be acceptable. The goal of a best fit line is to minimize the least squares error. This means that the sum of the vertical distances between the line and the points should be minimized as much as possible. In order to provide for a reasonable opportunity for the student to get the answer correct, this sum may be multiplied by a variability metric such as 150%.

This can be used for describing scatter plots in general. In addition, this technique well when used with linear data. Techniques described herein may also be used for scatter plots that have other trends, such as parabolic structures. This method can be used to identify patterns by drawing a convex hull around multiple smaller groups of points.

In an embodiment, given a set of points, circles are drawn around those points to create a more useful convex hull. While a convex hull may be drawn in an traditional manner (based on the points alone), such a structure would look rigid and would not draw as much attention to the trend as it would to the points on the outside of the convex hull.

In an embodiment, circles are generated from points and then a convex hull algorithm is applied. In an embodiment, the size of the circles may vary based on distance from other circles, the number of circles in a particular area of the graph, or other metrics. In an embodiment, the size of the circles are the same, and are determined as a function of the average distance between the points.

In an embodiment, given a set of points, a good size for circles associated with the points is determined. Using a convex hull algorithm, lines are drawn around the outside circles. If the circles are the wrong size, they are not useful. Circles that are too big are not representative of a trend, and circles that are too small are too chunky to show a trend.

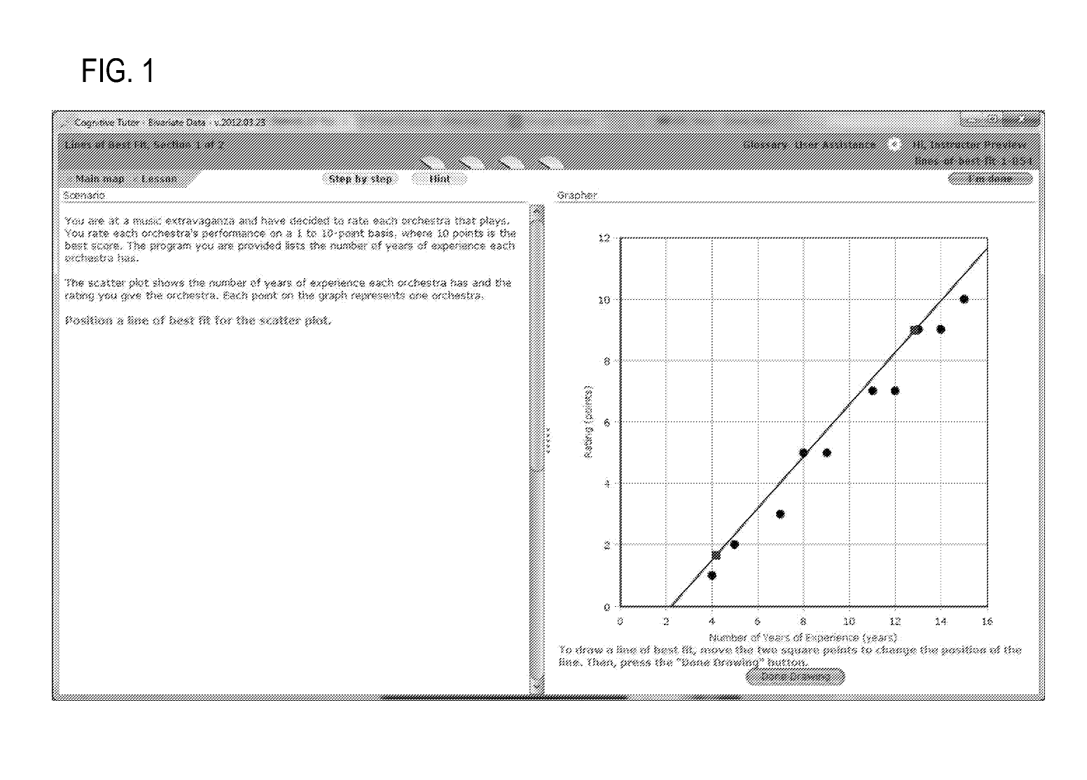

In the example shown in FIG. 1, the student positions the line of best fit (blue line) by dragging the blue squares (i.e., the point controls) until the line approximates the trend of the black dots. In this picture, the line would be accepted as a correct answer.

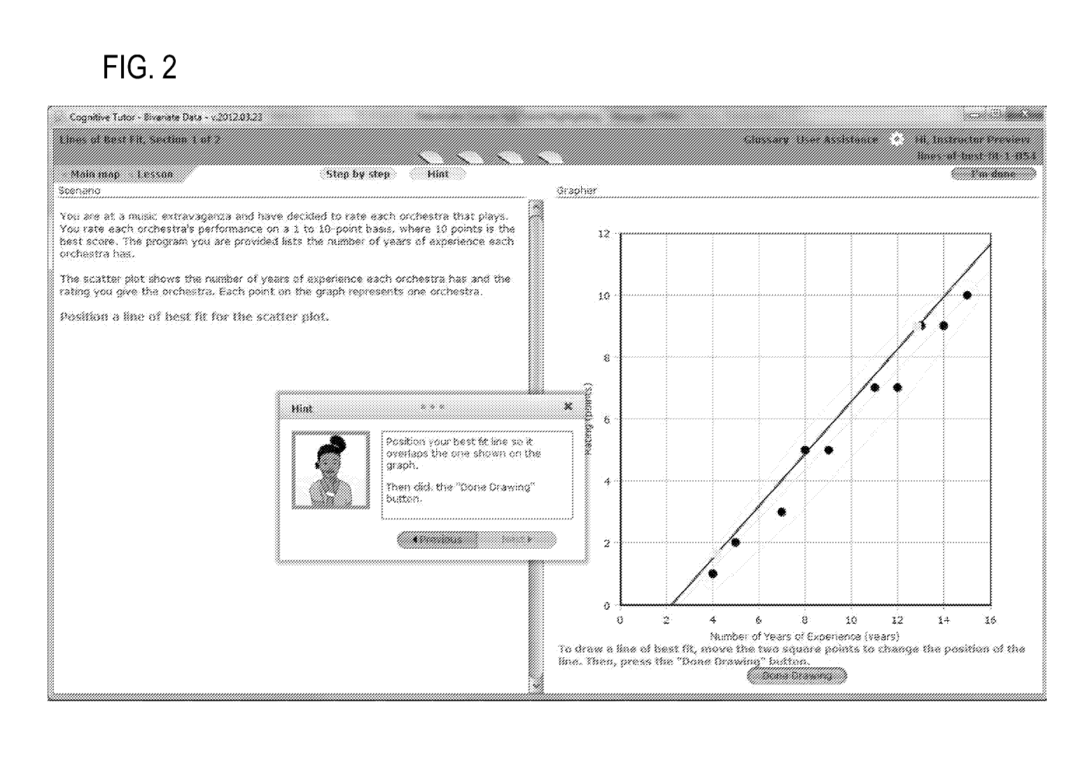

FIG. 2 shows the plot shown in FIG. 1, but the convex hull has been added. In addition, the actual line of best fit shown in yellow. The convex hull appears when the student requests the second level of the hint sequence:

This method could be used to give a sense of the trend of a data set in other applications. Note that this process is completely geometric, and isn't strongly tied to the statistical properties of the set of points. However, points that are generated linearly with low variance tend to create long, cigar-like shapes while sets that are not linear tend to create rounder, more circular shapes. These later ones don't have a clear directionality to them.

### Convex Hull

A convex set is a set that doesn't curve inwards or have any dents. For any two points in the set, every point on the line segment between them will also be in the set. For example, a convex set contains a line segment for any two points in the set:

x₁,x₂∈C, 0≦θ≦1 [symbol] θx₁+(1−θ)x₂∈C

The convex hull of a set of points or shapes is the smallest convex set containing those points or shapes.

The convex hull of a finite set of points is a polygon with vertices as those points. This representation is ugly and distracting. To work around this, a circle is drawn around each point and the convex hull is calculated around those circles. Each circle is like a peg in a board; the convex hull is the result of stretching a rope or rubber band around the pegs. In an embodiment, the radius of each circle may be a multiple (e.g., 0.4) of the average distance between the points, but said radius could be calculated some other way. There is no reason that they all have to be the same radius, but some method is used to determine a radius for each circle in an embodiment. To calculate the convex hull of those circles, a modified version of the algorithm described in Devillers's and Golin's “Incremental Algorithms for Finding the Convex Hulls of Circles and the Lower Envelopes of Parabolas” may be used. Their algorithm uses a balanced tree structure. The embodiment described below uses a circular list.

### EXAMPLE EMBODIMENT

In an embodiment, a user of an adaptive learning system is presented with a set of points. For example, the points could be in the form of a scatterplot based on Cartesian coordinates, and may be presented on a plane. The user may be asked to draw or position a “best-fit” line through the points. For example, FIG. 1 illustrates a user interface that instructs the user to position a best-fit line through a scatterplot.

In an embodiment, a user may be presented with a hint to assist the user with the task of positioning the line correctly. For example, the user may incorrectly position the line, resulting in the automatic presentation of a hint. Or the user may request a hint. In response to receiving a request for a hint related to the drawing or positioning of a best-fit line, a convex hull is generated. In an embodiment, the convex hull encompasses all of the points displayed. In another embodiment, one or more points may be excluded from the convex hull generating process.

In an embodiment, the convex hull is created to encompass circles that are generated based at least in part on the included points. For example, a circle (visible or not) is created around each point. Then, after creating the circles around each point, a convex hull is generated around the circles. This has the effect of creating an attractive shape with soft edges that lends itself to dissection with a best-fit line.

In an embodiment, the convex hull of the circles is generated using a conventional algorithm for convex hull generation that uses a balanced tree structure, such as the one described in Devillers's and Golin's “Incremental Algorithms for Finding the Convex Hulls of Circles and the Lower Envelopes of Parabolas.” In another embodiment, the convex hull of the circles may be generated by an algorithm that uses a circular list instead of a balanced tree structure.

FIG. 2 illustrates an embodiment of a user interface that includes the convex hull hint. When a user views the convex hull, they are more easily able to determine the appropriate location of the best-fit line by dissecting the convex hull with the line. In an embodiment, the user may reposition a line provided by the user interface. In another embodiment, the user may draw the best-fit line.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

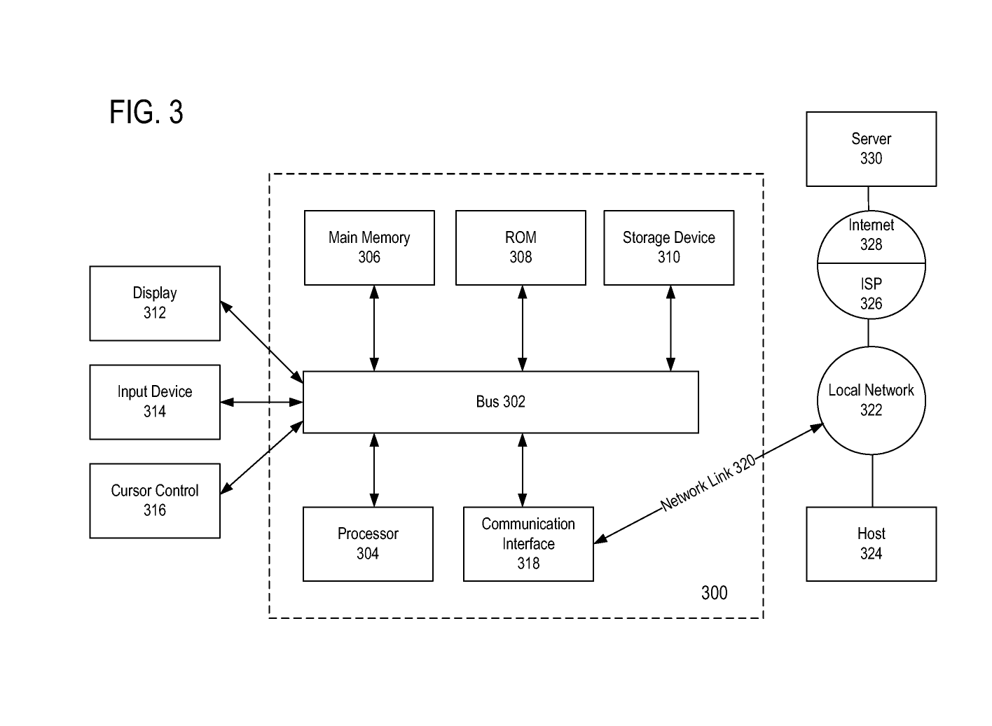

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
determining one or more circle sizes for a plurality of points;
based at least in part on the one or more circle sizes, generating a convex hull that encompasses the plurality of points;
wherein the method is performed by one or more computing devices.

2. The method of claim 1, wherein the points associated with the exterior edge of the convex hull are no closer to any one of the plurality of points than the radius of the smallest circle size.

3. The method of claim 1, further comprising:
generating a plurality of circles based at least in part on the one or more circle sizes;
wherein the points associated with the convex hull include or encompass the points associated with the plurality of circles.

4. The method of claim 1, wherein the steps of determining one or more circle sizes and generating a convex hull are performed in response to a user input, wherein the user input includes a request for a hint related to a question that is associated with the plurality of points.

5. A computer-readable storage medium storing instructions which, when executed by one or more processors, cause the one or more processors to perform:
determining one or more circle sizes for a plurality of points;
based at least in part on the one or more circle sizes, generating a convex hull that encompasses the plurality of points

6. The computer-readable storage medium of claim 5, wherein the points associated with the exterior edge of the convex hull are no closer to any one of the plurality of points than the radius of the smallest circle size.

7. The computer-readable storage medium of claim 5, wherein the instructions further include instructions for:
generating a plurality of circles based at least in part on the one or more circle sizes;
wherein the points associated with the convex hull include or encompass the points associated with the plurality of circles.

8. The computer-readable storage medium of claim 5, wherein the steps of determining one or more circle sizes and generating a convex hull are performed in response to a user input, wherein the user input includes a request for a hint related to a question that is associated with the plurality of points.
